(19) United States
(12) Patent Application Publication
(10) Pub. No.: US 2010/0218421 A1
(43) Pub. Date: Sep. 2, 2010

(54) Flowerpot shield

(76) Inventor: Robert H. Monnes, Randolph, MA (US)

Correspondence Address: StanfordPatents LLC, P.O. Box 8986, Mandeville, LA, 70470-8986, US

(21) Appl. No.: 12/380,521

(22) Filed: Feb. 27, 2009

(51) Int. Cl. A01G 13/02; A01G 9/00; A01G 13/00

(52) U.S. Cl. 47/29.5; 47/32; 47/31

(57) ABSTRACT

The present invention concerns a flowerpot soil protection apparatus featuring a porous stretchable elastic fabric cylinder, wherein the fabric, while stretchable, is carefully chosen to prevent entanglement with fingers and paws. The upper edge of the cylinder features an elasticized sleeve containing a drawstring enabling the upper edge of the stretchable elastic fabric cylinder to be drawn snugly around the stem of a potted plant and secured to maintain the snug fit; the bottom edge of the cylinder features a closed elasticized sleeve containing a closed ring of elasticized cord enabling the bottom edge of the stretchable elastic fabric cylinder to be drawn and held snugly around the rim of a flowerpot containing a potted plant. The apparatus is reusable and easily installed and removed from a variety of flower pots.

### BACKGROUND

1. Field of the Invention

The present invention concerns generally a protective shield for potted plants. In particular, the present invention is directed to an adjustable flower pot plant soil protector, safely preventing disturbance and depredation of the plant soil by small children or pets, while minimizing possible entanglement injury to either.

2. Description of the Related Art

Many dwellings, gardens, and patios feature potted plants as a desired decoration or adornment, expressing the personality and vitality of the occupants. Frequently, the adult occupants share these premises with small children and pets. For whatever reason, children and pets are often attracted to potted plants, with consequences that entail cleaning up scattered soil, removing animal waste, and sometimes repotting the plant, as well as the consequences associated with potential hazards to the health of both children and pets.

Protecting the soil in a flowerpot is not a new problem. As early as 1909, inventor, Matilda Skorness addressed this issue. U.S. Pat. No. 915,897 “Flowerpot Cover” is incorporated herein by reference for purposes of indicating the background of the present invention or illustrating the mature state of the art for protecting soil contained in a pot. In essence, her invention is a bifurcated rigid lid, pivotedly connected, enabling each semicircular section to close around a potted plant and protect the soil of that plant. In 1909, inventor Matilda Skorness' concern focused on preventing tobacco products from being discarded in the potted soil. It is not clear whether the diameter of the pot adversely affects the purpose of her invention.

More recently, in 1981, inventor Edward Markowitz developed a single disc plant protector. U.S. Pat. No. 4,395,845 “Plant Protector” is incorporated herein by reference for purposes of indicating the background of the present invention or illustrating the mature state of the art for plant protectors that are discs. In this invention, a disk-like cover is adapted to be friction fit within the interior walls of a flowerpot. To accommodate existing plants in a pot, a radial cut is made from the center hole of the disk to its outer extremity and the disc is deformed along the cut enabling the disk to be maneuvered around the stem of the existing plant. The purpose of this invention is to prevent moisture evaporation in the pot, discouraging the discarding of tobacco products in the pot, and additionally to prevent soil spilling out if the pot is knocked over.

Later in 1995, inventor Doris Holmes has returned to the bifurcated disk concept. In this instance, the invention involves open mesh fabric. U.S. Pat. No. 5,425,204 “Open Mesh Plant Soil Protector Apparatus” is incorporated herein by reference for purposes of indicating the background of the present invention or illustrating the mature state of the art in open mesh fabric potted soil protectors. Rather than pointedly discouraging the disposal of various tobacco products, the Holmes' invention and similar retail open mesh fabric soil protectors emphasize preventing children and small animals from accessing the soil containing the potted plant. One commercial vendor advertises an unpatented plant protection mesh net capable of stretching several times the original size of the open mesh.

Unfortunately, the open mesh fabric, particularly, the stretchable fishnet variety, can potentially victimize small children and animals, entangling their small fingers and paws, resulting in possible injury. Consequently, there is a need for an apparatus to protect the soil of potted plants from depredation by small children and animals without exposing those same small children and animals to possible finger or paw injury, or perhaps more serious, having been entangled, toppling and pulling the potted plant over upon the hapless victim.

### SUMMARY

An object of the present invention is to provide a potted plant shield that protects the soil in the potted plant from depredation by small children and animals, without those children and pets being victimized by the shield. Another object of the present invention is to provide a potted plant shield that utilizes a porous, stretchable elasticized fabric that prevents the small fingers of children and small paws of pets from being entangled. Another object of the present invention is to provide a potted plant shield that may be utilized on pots and plant stems of varying diameter. Another object of the present invention is to provide a potted plant shield that is economical to manufacture, permitting mass production. Yet another object of the present invention is to provide a potted plant shield that is durable, easy to install on a potted plant, easy to remove from a potted plant, and easy to install on another pot. A further object of the present invention is to provide a potted plant shield that permits hydration and aeration of the potted soil without having to first remove the shield. Another object of the present invention is to provide a potted plant shield that is washable and reusable. Another object of the present invention is to provide a potted plant shield that does not require cutting, trimming, or slitting prior to use.

### BRIEF DESCRIPTION OF THE DRAWINGS

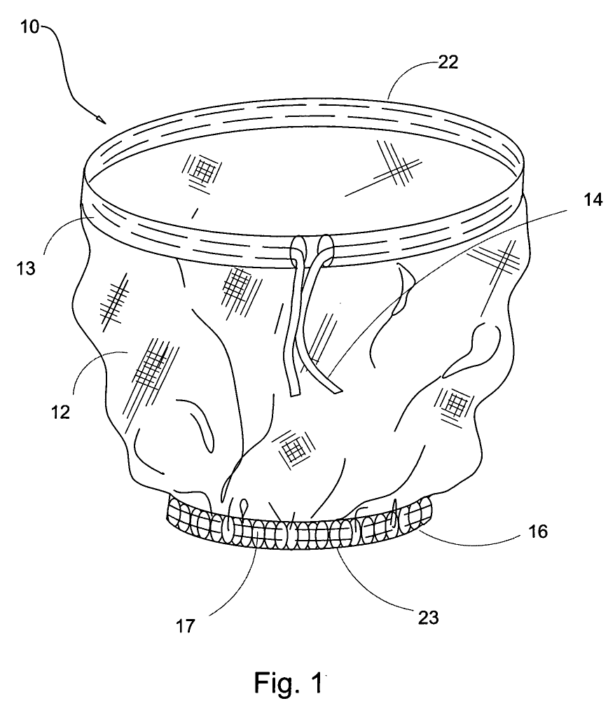

1. FIG. 1 is a frontal perspective view, illustrating an embodiment of the present invention, flowerpot shield 10. As shown, flowerpot shield 10 comprises a porous, stretchable elastic fabric cylinder 12, having an open top edge 22 and an open bottom edge. 23. The open top edge 22 of the stretchable elastic fabric cylinder 12 is formed into a contraction casing 13, encasing a drawstring 14, and further providing an opening for the ends of drawstring 14 to extend therethrough. Contraction casing 13 is puckered when operatively engaged. The open bottom edge 23 of the stretchable elastic fabric cylinder 12 is formed into an expansion casing 16, totally encasing a generally circular closed elastic cord 17. Expansion casing 16 is generally puckered when not operatively engaged.

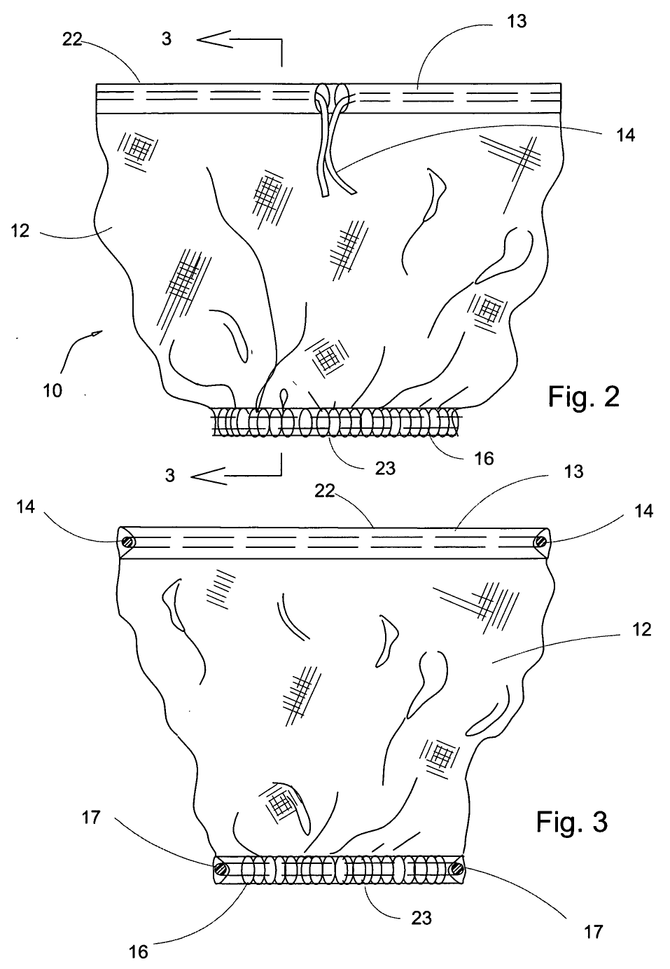

2. FIG. 2 is a frontal view, illustrating an embodiment of the present invention 10, depicting the stretchable elastic fabric cylinder 12, exhibiting contraction casing 13, operatively unengaged and consequently not puckered, drawstring 14, expansion casing 16, operatively unengaged and consequently generally puckered.

3. FIG. 3 is a cross-sectional view of FIG. 2 of a preferred embodiment of the present invention flowerpot shield 10, showing stretchable elastic fabric cylinder 12, with contraction casing 13 formed around the open top edge 22 of cylinder 12. This sectional view shows drawstring 14 encased within contraction casing 13. Expansion casing, 16 is formed around the open bottom edge 23 of cylinder 12, totally encasing closed elastic cord 17.

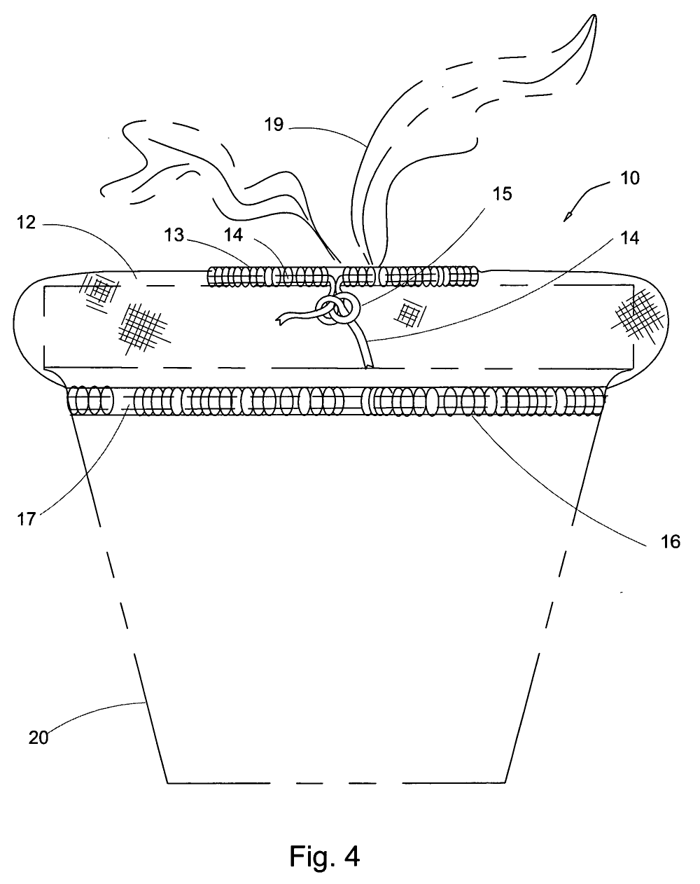

4. FIG. 4 is a frontal view of the preferred embodiment of the present invention flowerpot shield 10, operatively engaged with a flowerpot 20 (not claimed in the present invention), containing a potted plant 19 (not claimed in the present invention). FIG. 4 illustrates the general operative configuration of the present invention when protecting the potted soil within flowerpot 20 from prying fingers and paws. When operatively engaged, stretchable elastic fabric cylinder 12 essentially covers the top of flowerpot 20; drawstring 14 is drawn around the potted plant 19 and secured with drawstring fastener 15, resulting in a puckered contraction casing 13; closed elastic cord 17, totally encased within expansion casing 16 conforms snugly around the periphery of flowerpot 20, generally producing a partially puckered expansion casing 16.

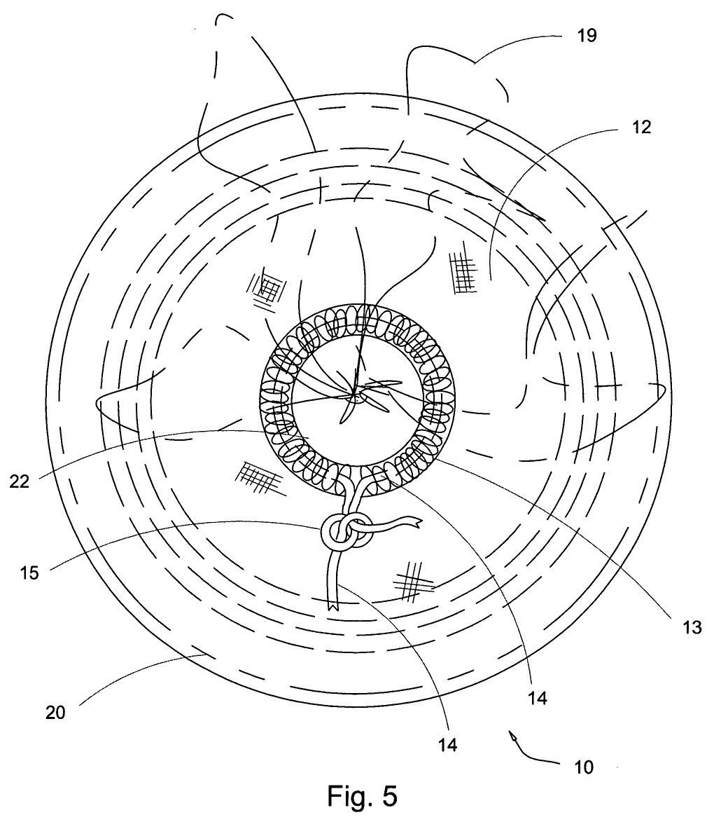

5. FIG. 5 is a top view of the preferred embodiment of the present invention, flowerpot shield 10, operatively configured, covering and protecting soil surrounding a potted plant 19 contained in flowerpot 20. In this illustration, FIG. 5, stretchable elastic fabric cylinder 12 has been drawn over the upper edge of flowerpot 20 and drawstring 14 has been drawn, causing contraction casing 13 to closely encircle the principal stem of potted plant 19. Tension on drawstring 14 is maintained with drawstring fastener 15, in this instance, a simple knot.

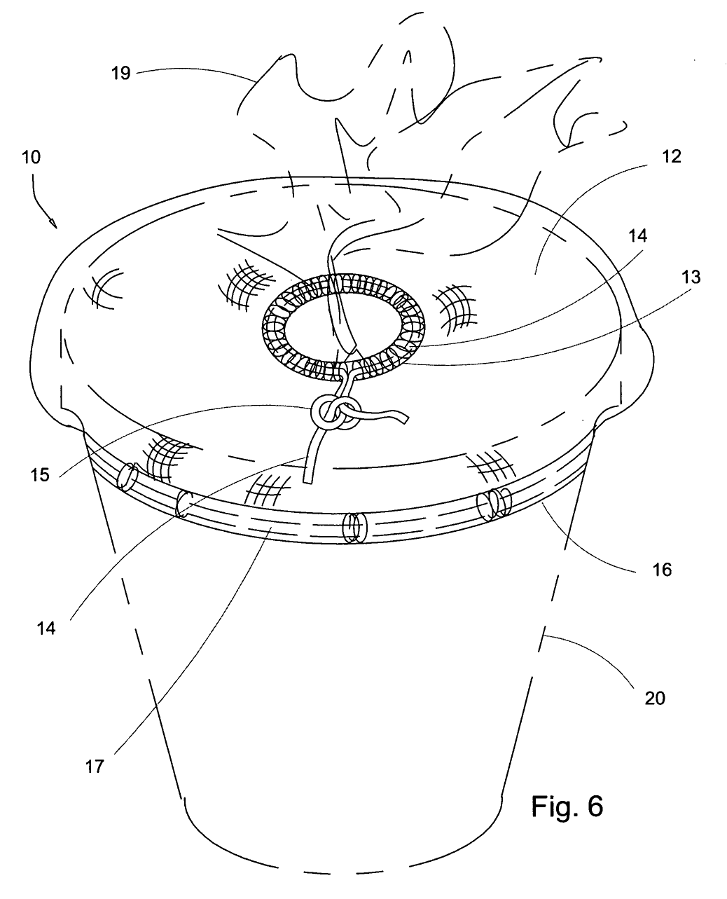

6. FIG. 6 is a frontal perspective view of a preferred embodiment of the present invention 10, depicting an operative configuration wherein stretchable elastic fabric cylinder 12 is drawn over the edge of flowerpot 20; contraction casing 13 is drawn closely around the stem of potted plant 19 by means of drawstring 14, whose tension is maintained by drawstring fastener 15, in this instance, a simple knot; and expansion casing 16, snugly positioned around flowerpot 20 by tension from closed elastic cord 17.

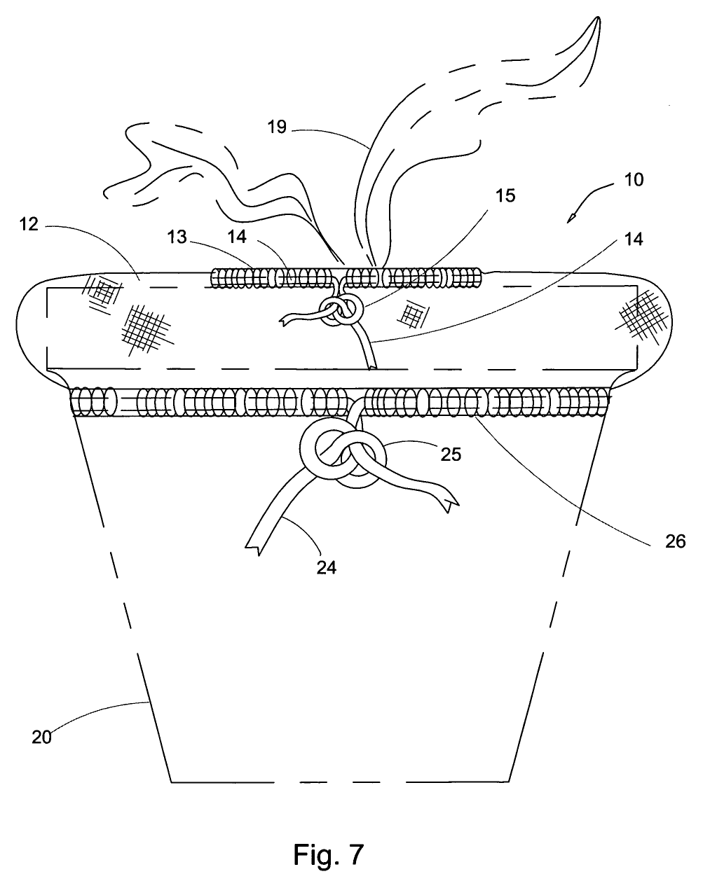

7. FIG. 7 is a frontal view of an alternate embodiment of the present invention flowerpot shield 10, operatively engaged with a flowerpot 20 (not claimed in the present invention), containing a potted plant 19 (not claimed in the present invention). FIG. 7 illustrates the general operative configuration of the present invention when protecting the potted soil within flowerpot 20 from prying fingers and paws. When operatively engaged, stretchable elastic fabric cylinder 12 essentially covers the top of flowerpot 20;

drawstring 14 is drawn around the potted plant 19 and secured with drawstring fastener 15, resulting in a puckered contraction casing 13. In a manner similar to the employment of contraction casing 13, drawstring 14, and drawstring fastener 15, expansion casing drawstring 24, expansion casing drawstring fastener 25, and modified expansion casing 26 are combined to conform modified expansion casing 26 securely around the periphery of flowerpot 20.

### DESCRIPTION OF THE PREFERRED EMBODIMENT

The preferred embodiment of an adjustable flowerpot plant soil protector according to the present invention is generally a flowerpot shield 10, aptly illustrated in FIG. 1-FIG. 6, principally comprising a porous stretchable elastic fabric cylinder 12. Manufacture of fabric cylinder 12 is selected from a group of manufacturing techniques consisting of a woven cylinder, a cylinder formed from a single piece of fabric, and a cylinder formed from multiple pieces of fabric. The fabric for fabric cylinder 12 is carefully selected to allow hydration and aeration of the soil surrounding potted plant 19 (not claimed in present invention) in flowerpot 20 (not claimed in present invention) while preventing entanglement of small fingers and animal paws. Fabric cylinder 12, shown in FIG. 1, has an open top edge 22, shown in FIG. 1 and FIG. 3, and an open bottom edge 23, shown in FIG. 3. The upper edge of the perimeter, defining open top edge 22 of fabric cylinder 12 is folded back upon itself and fixed, forming contraction casing 13, casing 13 thereby circumscribing open top edge 22. As illustrated in FIG. 1, casing 13 provides an encasing sleeve for drawstring 14, and further provides an opening for the ends of drawstring 14 to extend therethrough. Contraction casing 13 is puckered when operatively engaged. When flowerpot shield, 10 is operatively engaged, drawstring 14 may be secured with a drawstring fastener 15, shown in FIG. 4 and FIG. 5. Drawstring fastener 15 is selected from a group of fastener is consisting of a simple knot, a clamp, and a commercially available drawstring fastener.

The lower edge of the perimeter, defining open bottom edge 23 of fabric cylinder 12 is folded back upon fabric cylinder 12 and fixed, forming expansion casing 16, casing 16 thereby circumscribing open bottom edge 23. Thus formed, casing 16 provides an operative sleeve and totally encases a generally circular closed elastic cord 17. Expansion casing 16 is generally puckered when not operatively engaged.

The sectional view, FIG. 3, of flowerpot shield 10 provides additional detail of assembly. Contraction casing 13, formed from fabric defining the circular perimeter of open top edge 22 of elastic fabric cylinder 12 folded back upon itself and fixed, provides an operative sleeve for drawstring 14. Casing 13 is fixed by a fixing means selected from a group of fixing means consisting of sewing, gluing, and stapling. Drawstring 14 is threaded through the operative sleeve of casing 13 and can be removed if necessary.

Expansion casing 16 is formed from fabric defining the circular perimeter of open bottom edge 23 of elastic fabric cylinder 12 by folding the material of casing 16 back upon itself and fixed, thereby providing an operative sleeve for closed elastic cord 17. Casing 16 is fixedly placed by a fixing means selected from a group of fixing means consisting of sewing, gluing, and stapling. Contrary to the fabrication of casing 13, casing 16 provides an operative sleeve that totally encases closed elastic cord 17 and cord 17 may not be readily removed following fabrication.

FIG. 4, FIG. 5, and FIG. 6 each illustrate the employment of flowerpot shield 10 to operatively protect the soil surrounding potted plant 19 contained in typical flowerpot 20. To install flowerpot shield 10, first, the open top edge 22 is drawn onto the base of flowerpot 20 and pulled upward, similar to putting on a stocking. Expansion casing 16 follows and is drawn to a snug position just below the reinforced rim of the typical flowerpot 20. At this point, contraction casing 13 is approximately level with the rim of flowerpot 20 and totally encircles potted plant 19.

Second, as shown in FIG. 5 and FIG. 6, drawstring 14 is drawn up to snugly encircle the stem or trunk of potted plant 19 and drawstring fastener 15 is made fast to maintain this configuration.

In these two simple steps, flowerpot shield 10 is effortlessly installed, and immediately protects the soil contents of the flowerpot 19 from prying and exploring fingers and paws while readily permitting hydration and aeration of those soil contents.

An alternative embodiment of the present invention substitutes expansion casing drawstring 24, expansion casing drawstring fastener 25, and modified expansion casing 26, replacing expansion casing 16 and closed elastic cord 17, for effectively and securely conforming modified expansion casing 26 around the periphery of flower pot 20.

Although only a few exemplary embodiments of the invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structure described herein as performing the recited functions and not only structural equivalents but also equivalent structures.

What is claimed is:

1. A flowerpot shield for safely preventing disturbance and depredation by small children and pets of the plant soil associated with a potted plant, said flowerpot shield comprising,
a select fabric cylinder, said cylinder having an open top edge and an open bottom edge, said cylinder fabricated from stretchable elastic material, enabling said cylinder to be readily placed around and totally encompass the outer circumference of a flower pot containing a plant and its associated plant soil to be protected, the elastic material further being operatively porous, allowing hydration and aeration of the soil surrounding the potted plant, the elastic material operatively further featuring a sufficiently limited expansion mesh for preventing insertion and entanglement of juvenile fingers and pet paws therethrough;
contraction means for maintaining said open top edge operatively snugly encompassing principal stem and stems of potted plant;
expansion means for maintaining said open bottom edge operatively snugly encompassing rim of flowerpot containing plant;
said flowerpot shield operatively pulled over the base of a flowerpot containing a plant whose soil is to be protected, said shield moved upwards toward the rim of the flowerpot and operatively configured, said expansion means operatively engaging and snugly encompassing the rim of the flowerpot, said contraction means operatively engaging and snugly encompassing principal stem and stems of the plant in the flowerpot, said flowerpot shield providing plant soil protection, preventing disturbance and depredation of the plant soil by small children and pets and further preventing insertion and entanglement of their juvenile fingers and paws in said flowerpot shield and possible resultant injury.

2. A flowerpot shield for safely preventing disturbance and depredation by small children and pets of the plant soil associated with a potted plant, as recited in claim one, wherein fabrication of said select fabric cylinder is selected from a group of fabrication techniques, consisting of a single woven cylinder, a cylinder formed from a single piece of fabric, and a cylinder formed from multiple pieces of fabric.

3. A flowerpot shield for safely preventing disturbance and depredation by small children and pets of the plant soil associated with a potted plant, as recited in claim two, wherein said contraction means comprises a contraction casing, said contraction casing formed by folding said open top edge back upon surface of said fabric cylinder and operatively fixed thereto by open top edge fixing means, encompassing the circumference of said cylinder, said contraction casing operatively receiving a circumferential drawstring therein, said drawstring having two operative ends, each end of said drawstring operatively extending through a common aperture in said contraction casing for drawing and contracting said contraction casing snugly against the stem and stems of the potted plant, said drawstring maintaining said contraction casing snugly against the stem and stems of a potted plant by drawstring fastening means.

4. A flowerpot shield for safely preventing disturbance and depredation by small children and pets of the plant soil associated with a potted plant, as recited in claim three, wherein said open top edge fixing means is selected from a group of fixing techniques consisting of stitching, stapling, and gluing.

5. A flowerpot shield for safely preventing disturbance and depredation by small children and pets of the plant soil associated with a potted plant, as recited in claim three, wherein said drawstring fastening means is selected from a group of fasteners consisting of a simple knot, a clamp, and a commercially available drawstring fastener.

6. A flowerpot shield for safely preventing disturbance and depredation by small children and pets of the plant soil associated with a potted plant, as recited in claim two, wherein said expansion means comprises an expansion casing, said expansion casing formed by folding said open bottom edge back upon surface of said fabric cylinder and operatively fixed thereto by open bottom edge fixing means, encompassing the circumference of said cylinder, said expansion casing operatively receiving a circumferential closed elastic cord wholly therein, for maintaining said expansion casing snugly against the outer circumference of the pot containing the potted plant.

7. A flowerpot shield for safely preventing disturbance and depredation by small children and pets of the plant soil associated with a potted plant, as recited in claim six, wherein said open top edge fixing means is selected from a group of fixing techniques consisting of stitching, stapling, and gluing.

8. A stretchable fabric flowerpot shield for safely preventing disturbance and depredation of soil surrounding a potted plant by small children and pets, said flowerpot shield comprising,
a cylinder, fabricated from porous stretchable elastic fabric, porosity and elasticity of fabric of said cylinder allowing hydration and aeration of the soil surrounding the potted plant while operatively limited in mesh expansion, preventing insertion of juvenile fingers and pet paws therethrough, said cylinder having an open top edge and an open bottom edge, said open top edge folded back upon outer surface of said cylinder and operatively fixed thereto by open top edge fixing means, forming a contraction casing, said contraction casing fully encompassing resulting open top of said cylinder, said contraction casing operatively snugly by casing contraction means, encompassing the principal stem and stems of the potted plant, said open bottom edge folded back upon outer surface of said cylinder and operatively fixed thereto by open bottom edge fixing means, forming an expansion casing, said expansion casing fully encompassing resulting open bottom of said cylinder, said contraction casing operatively snugly fitted around rim of pot containing plant;
casing contraction means for maintaining said contraction casing operatively snugly fitted around principal stem and stems of potted plant;
casing expansion means for maintaining said expansion casing operatively snugly fitted around rim of pot containing plant;
said flowerpot shield operatively pulled over the base of a pot containing a plant to be protected, moved upwards toward the rim of the pot and operatively configured, said expansion casing operatively engaging and snugly fitted along rim of the pot, said contraction casing operatively engaging and snugly fitted around principal stem and stems of the plant in the pot, said flowerpot shield providing plant soil protection, preventing disturbance and depredation of the plant soil by small children or pets, while preventing insertion and possible entanglement by the juvenile fingers and paws thereof.

9. A stretchable fabric flowerpot shield for safely preventing disturbance and depredation of soil surrounding a potted plant by small children and pets, as recited in claim eight, wherein said casing contraction means comprises said contraction casing operatively receiving a circumferential drawstring therein, said drawstring having two operative ends, each end of said drawstring operatively extending through a common aperture in said contraction casing for drawing and contracting said contraction casing snugly against the principal stem and stems of the potted plant, said drawstring maintaining said contraction casing snugly against the principal stem and stems of it the potted plant by drawstring fastening means.

10. A stretchable fabric flowerpot shield for safely preventing disturbance and depredation of soil surrounding a potted plant by small children and pets, as recited in claim nine, wherein said drawstring fastening means is selected from a group of fasteners, consisting of a simple knot, a clamp, and a commercially available drawstring fastener.

11. A stretchable fabric flowerpot shield for safely preventing disturbance and depredation of soil surrounding a potted plant by small children and pets, as recited in claim eight, wherein said casing expansion means comprises said expansion casing operatively receiving a circumferential closed elastic cord wholly therein, for maintaining said expansion casing snugly against the outer circumference of the pot containing the potted plant.

12. A stretchable fabric flowerpot shield for safely preventing disturbance and depredation of soil surrounding a potted plant by small children and pets, as recited in claim eight, wherein said casing expansion means comprises a modified expansion casing operatively receiving a circumferential expansion casing drawstring therein, said expansion casing drawstring having two operative ends, each end of said expansion casing drawstring operatively extending through a common aperture in said modified expansion casing for drawing and contracting said modified expansion casing snugly against the outer circumference of the pot containing the potted plant.

13. A stretchable fabric flowerpot shield for safely preventing disturbance and depredation of soil surrounding a potted plant by small children and pets, as recited in claim twelve, wherein fastening said expansion casing drawstring is selected from a group of fasteners, consisting of a simple knot, a clamp, and a commercially available drawstring fastener.

14. A stretchable fabric flowerpot shield for safely preventing disturbance and depredation of soil surrounding a potted plant by small children and pets, said flowerpot shield comprising,
a cylinder, fabricated from porous stretchable elastic fabric, porosity and elasticity of fabric of said cylinder allowing hydration and aeration of the soil surrounding the potted plant while operatively limited in mesh expansion, preventing insertion of juvenile fingers and pet paws therethrough, said cylinder having an open top edge and an open bottom edge;
a contraction casing, said contraction casing formed by folding said open top edge back upon said cylinder and operatively fixed thereto by stitching, said contraction casing fully encompassing resulting open top of said cylinder;
a drawstring, said drawstring operatively circumferentially received within said contraction casing, said drawstring having two ends, each end of said drawstring operatively extending through a common aperture in said contraction casing for drawing and contracting said contraction casing snugly against the principal stem and stems of the potted plant, said drawstring secured with a simple knot, maintaining said contraction casing snugly against the principal stem and stems of the potted plant; and
an expansion casing, said expansion casing formed by folding said open bottom edge back upon said cylinder and operatively fixed thereto by stitching, said expansion casing fully encompassing resulting open bottom of said cylinder, said expansion casing operatively receiving a circumferential closed elastic cord wholly therein, said contraction casing operatively snugly fitted around rim of pot containing plant; for maintaining said expansion casing snugly against the outer circumference of the pot containing the potted plant;
said flowerpot shield operatively pulled over the of a pot containing a plant to be protected, moved upwards toward the rim of the pot and operatively configured, said expansion casing operatively engaging and snugly fitted along rim of the pot, said contraction casing drawn tight with said drawstring, said drawstring secured with a simple knot, said contraction casing operatively engaging and snugly fitted around principal stem and stems of the plant in the pot, said flowerpot shield providing plant soil protection, preventing disturbance and depredation of the plant soil by small children or pets, while preventing insertion and possible entanglement by the juvenile fingers and paws thereof.
